(19) United States
(12) Patent Application Publication
(10) Pub. No.: US 2018/0180431 A1
(43) Pub. Date: Jun. 28, 2018

(54) Determining Commute Tolerance Areas

(71) Applicant: Google Inc., Mountain View, CA (US)

(72) Inventors: Jennifer Su, Mountain View, CA (US); Qi Zhu, San Francisco, CA (US)

(21) Appl. No.: 15/387,725

(22) Filed: Dec. 22, 2016

(51) Int. Cl. G01C 21/34; G01C 21/36; G06Q 10/10

(52) U.S. Cl. CPC G01C 21/3484; G06Q 10/1053; G01C 21/3691

(57) ABSTRACT

Systems and methods of determining commute tolerance areas are provided. For instance, profile data associated with a user can be obtained. Transportation data associated with a geographic area can be obtained. The geographic area can be determined based at least in part on the profile data. A frequently traveled commute of the user within the geographic area can be determined based at least in part on an origin location and a destination location. The origin location and the destination location can be determined based at least in part on the profile data. A commute time associated with the frequently traveled commute can be determined based at least in part on the origin location and the destination location and the transportation data. A commute tolerance area within the geographic area can be determined based at least in part on commute time.

### FIELD

The present disclosure relates generally to determining commute tolerance areas for users.

### BACKGROUND

In recent years, job posting services have become a popular mechanism for providing an avenue for employers, staffing agencies, recruiters, etc. to provide information to users about available job openings. For instance, such entities can post job postings associated with available jobs at a job posting service, such as a job search engine, job aggregator, social network site, professional networking site, or other suitable job posting service. The job postings can include various characteristics associated with the corresponding job (e.g., title, location, description, requirements, salary, etc.). In this manner, users of the job posting services can be alerted to available jobs.

Many such job posting services can include various filters or other suitable tools or techniques to surface job postings that may be relevant to the user. Such tools can allow a user to search or browse for jobs located within a particular area (e.g. a particular city) that are applicable to the user's education level, experience, salary requirements, etc. Some job posting services may allow a user to search for jobs within a certain distance of the user's residence. For instance, the user can search for jobs within 10 miles of the user's residence, and the job posting service can surface job postings within a 10 mile radius of the user's residence. In this manner, the user can search for jobs to which the user is willing to travel. However, such techniques do not account for temporal requirements in traveling to the job. Consequently, a user may be presented with a surfeit of information concerning jobs that are located within a certain distance of the user's residence, but which are nonetheless unsuitable owing to difficulties in reaching the site within an acceptable timeframe. The effectiveness of the job posting service for users is, therefore, compromised as users are imposed with the burden of sifting through the various postings to determine those jobs that are genuinely worth pursuing and filtering out those jobs for which the temporal requirements in traveling to the job site rule them out from further consideration.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of determining a commute tolerance for a user. The method includes obtaining, by one or more computing devices, profile data associated with a user. The method further includes obtaining, by the one or more computing devices, transportation data associated with a geographic area, the geographic area being determined based at least in part on the profile data. The method further includes determining, by the one or more computing devices, a frequently traveled commute of the user within the geographic area based at least in part on an origin location and a destination location determined based at least in part on the profile data. The method further includes determining, by the one or more computing devices, a commute time associated with the frequently traveled commute based at least in part on the origin location and the destination location and the transportation data. The method further includes determining, by the one or more computing devices, a commute tolerance area within the geographic area based at least in part on commute time and the transportation data. The method further includes selecting, by the one or more computing devices, one or more objects for display to the user based at least in part on the commute tolerance area.

Another example aspect of the present disclosure is directed to a computer-implemented method of performing an online search. The method may include receiving a search query from a user. In one example, the query may relate to job postings. Upon receipt of the search query, the method may include obtaining, by one or more computing devices, profile data associated with the user and obtaining, by the one or more computing devices, transportation data associated with a geographic area, the geographic area being determined based at least in part on the profile data. The method may further include determining, by the one or more computing devices, a frequently traveled commute of the user within the geographic area based at least in part on an origin location and a destination location determined based at least in part on the profile data. The method may further include determining, by the one or more computing devices, a commute time associated with the frequently traveled commute based at least in part on the origin location and the destination location and the transportation data. The method may further include determining, by the one or more computing devices, a commute tolerance area within the geographic area based at least in part on commute time and the transportation data. The method may further include retrieving search results associated with locations that lie within the commute tolerance area and returning the results to the user.

Other example aspects of the present disclosure are directed to systems, apparatus, tangible, non-transitory computer-readable media, user interfaces, memory devices, and electronic devices for determining commute tolerance areas for users.

By determining the commute tolerance for a user, embodiments can help to filter postings or search results in such a way as to prioritize those associated with locations that can be reached within an acceptable timeframe from the user's start point (for example, the user's residence). Users are, in turn, spared the necessity of having to sort through these results to identify ones that can be reached within an acceptable timeframe. Limiting the postings and/or search results to ones that can be reached in a suitable time may also provide savings in terms of network usage, since in many cases, only a subset of those results that would normally be sent to the user will meet the user's requirements in terms of travel time, and so the overall amount of data that needs to be sent to the user can be reduced.

These and other features, aspects and advantages of various embodiments will become better understood with reference to the following description and appended claims. It will be understood that embodiments described herein may include the features of one or more of the claims in any combination. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system for determining commute tolerance areas according to example embodiments of the present disclosure;

FIG. 2 depicts a representation of an example travel route associated with a frequently traveled commute according to example embodiments of the present disclosure;

FIG. 3 depicts a representation of an example commute tolerance area according to example embodiments of the present disclosure;

FIG. 4 depicts a flow diagram of an example method of determining a commute tolerance area according to example embodiments of the present disclosure;

FIG. 5 depicts a flow diagram of an example method of determining a commute tolerance area according to example embodiments of the present disclosure;

FIG. 6 depicts a flow diagram of an example method of surfacing relevant job postings according to example embodiments of the present disclosure; and

FIG. 7 depicts an overview of an example system according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to determining commute tolerances for users. A commute for a user can be described by a temporal length (e.g. an amount of time of the commute) of the commute and/or by a physical length of the commute. A commute tolerance for a user can correspond to a temporal length and/or a physical length that the user is willing to travel in the user's “daily” commute (e.g. commute to work, commute to school, etc.). In this manner, profile data associated with a user can be obtained. Transportation data associated with a geographic area corresponding to the profile data can also be obtained. An origin location and a destination location can be identified from the profile data, and a frequently traveled commute can be determined based at least in part on the origin location and the destination location. The frequently traveled commute can be associated with one or more modes of transportation. A commute time associated with the frequently traveled commute can be determined. A commute tolerance area can be determined within the geographic area can be determined based at least in part on the commute time and the transportation data.

More particularly, the profile data associated with the user can include various suitable data. For instance, the profile data can include data relating to a resume of the user, a social network profile of the user, a professional network profile of the user, a profile associated with a suitable job aggregator, job search engine, etc., or other suitable profile data. In this manner, the profile data can be obtained from various suitable sources. The profile data can include an origin location and a destination location associated with a commute of the user. For instance, the origin location can correspond to a home address or other indicator describing the user's residence specified in the profile data. The destination location can correspond to a work address, school address, etc. specified in the profile data.

The profile data can be analyzed, for instance, by a computing system to identify the origin location and/or the destination location. The profile data can specify the origin location and/or the destination location at varying levels of granularity. For instance, the profile data may include a full residential address and/or a full work or school address. As another example, the profile data may include less specific indicators. For instance, the profile data may include a name of one or more employers of the user, but may not specify an address of the employer. In this manner, in instances wherein the origin location and/or the destination location are specified with high granularity (e.g. a full address is provided), the origin location and/or the destination location can be identified directly from the profile data. In instances wherein the origin location and/or the destination location are specified with a low level of granularity (e.g. less than a full address is provided), such that the origin location and/or the destination location cannot be identified directly from the profile data, the origin location and/or the destination location can be determined from one or more alternate sources. For instance, the computing system can perform a look-up of a specified employer name to ascertain an address of the employer.

In some implementations, a confidence score associated with the profile data can be determined. The confidence score can reflect a degree of confidence in the accuracy of the information included in the profile data. In this manner, a higher confidence score can reflect a greater confidence in the accuracy of the profile data, and a lower confidence sore can reflect a lesser confidence in the accuracy of the profile data. The confidence score can be determined based at least in part on a source of the profile data, an age of the profile data (e.g. based on when the profile data was added), and/or other suitable metric. In some implementations, the confidence score can be associated with the identified or determined origin location and destination location.

A frequently traveled commute can be determined based at least in part on the origin location and the destination location. For instance, the frequently traveled commute can be associated with a travel route between the origin location and the destination location. The travel route can be associated with one or more modes of transportation. For instance, the travel route can be associated with one or more of walking, biking, driving, public transportation (bus, metro, taxi, subway, train, etc.), or other suitable mode of transportation. As an example, a first portion of the travel route can be associated with a first mode of transportation, and a second portion of the travel route can be associated with a second mode of transportation. The travel route can be determined using any suitable routing technique. In some implementations, the travel route can be determined based at least in part on transportation data associated with the geographic area. For instance, such transportation data associated with the geographic area can be obtained by the computing system. The transportation data can include traffic data, public transit data (e.g. data indicative of routes, schedules, etc. of various suitable forms of public transit present in the geographic area), user data (e.g. survey data or other data specifying preferred user modes of transportation within the geographic area, or other user data), or other suitable data relating to various modes of transportation within the geographic area. The transportation data can be used to determine a suitable traffic route that the user likely travels on the user's commute.

A commute time can further be determined based at least in part on the travel route. For instance, the commute time can be an expected time required to travel from the origin location to the destination location by traversing the travel route. The commute time can be determined based at least in part on the transportation data. For instance, the commute time can be determined based at least in part on public transit routes, public transit schedules, traffic data associated with the geographic area, etc.

The commute time can correspond to a commute tolerance of the user. In this manner, the commute time can represent an amount of time that the user is willing to travel in commuting to work, school, etc. More particularly, it can be inferred that the user is willing to travel for a period of time generally corresponding to the commute time. In this manner, a commute tolerance area can be determined based at least in part on the commute time.

The commute tolerance area can be an area within the geographic area. More particularly, the commute tolerance area can be a multidirectional area that surrounds the origin location (e.g. the user's residence) that specifies a plurality of commutes that can be traveled by the user in a time less than or equal to the commute time. In this manner, a plurality of candidate travel routes can be determined between the origin location and a plurality of destination locations in a plurality of directions. The candidate travel routes can each be associated with one or more modes of transportation. A plurality of tolerable travel routes can be selected from the plurality of candidate travel routes. The tolerable travel routes can be travel routes that can be traversed in a time less than or equal to the determined commute time. The commute tolerance area can be determined based at least in part on the selected tolerable travel routes.

More particularly, the commute tolerance area can be determined to encompass each tolerable travel route. In this manner, the commute tolerance area can represent an area in which the user is willing to commute on a daily or other basis. The commute tolerance area can have an irregular, multidirectional shape. In some implementations, the perimeter of the commute tolerance area can intersect the destination locations of one or more tolerable travel route. In some implementations, the shape of the commute tolerance area can be determined based at least in part on a plurality of apex destination locations of a plurality of tolerable travel routes. An apex destination location can be the destination location associated with a tolerable travel route having the farthest distance from the origin location in a particular direction. In such implementations, the perimeter of the commute tolerance area can intersect with at least one apex destination location.

According to example aspects of the present disclosure, one or more objects can be selected for display to the user based at least in part on the commute tolerance area. The one or more objects can be indicative of job postings that may be relevant to the user based at least in part on the commute tolerance area. In this manner, job posting data can be obtained from one or more sources. Such job posting data can describe one or more job opportunities posted by various third party entities, such as employers, staffing agencies, recruiters, etc. For instance, the job posting data can be obtained by a computing system configured to crawl webpages (e.g., employer job listing pages, job sites, recruiting sites, social media, professional networking sites) to obtain the data indicative of the job postings. Such data can include one or more characteristic(s) associated with the job postings. In particular, such data can include respective locations of the jobs for which job postings reference.

The location of the job postings can be compared to the commute tolerance area associated with the user to identify one or more relevant job postings having associated locations within the commute tolerance area. In some implementations, such data indicative of such relevant job postings can be provided to a user computing device associated with the user. In some implementations, user data associated with the user (e.g. the profile data or other data associated with the user) can be provided to one or more entities that posted the relevant job postings.

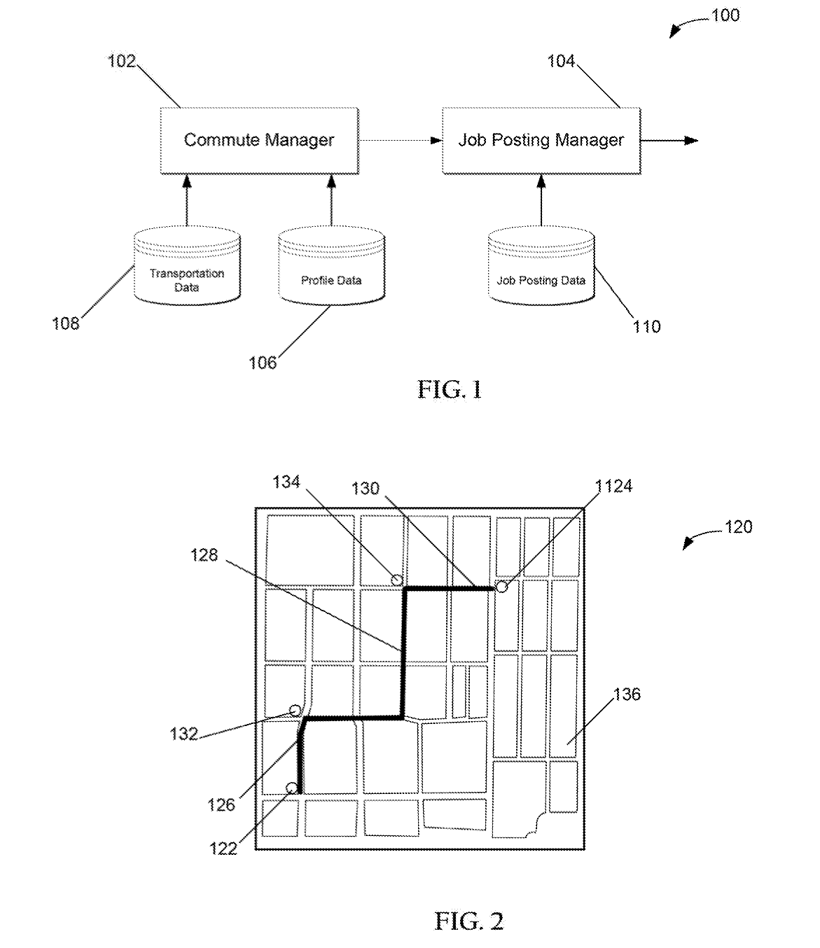

With reference now to the figures, example aspects of the present disclosure will be discussed in greater detail. For instance, FIG. 1 depicts a block diagram of an example system 100 for determining commute tolerance areas for surfacing relevant job postings according to example embodiments of the present disclosure. The system 100 can be implemented by any suitable computing device(s), such as a user computing device associated with a user and/or a server computing device (e.g. web server). The system 100 includes a commute manager 102 and a job posting manager 104.

The commute manager 102 can be configured to obtain profile data 106 associated with a user. For instance, the profile data 106 can include data indicative of a social media profile, a professional network profile, a resume, a work history, a job search site profile, a job aggregator profile, and/or other suitable profile data associated with a user. The profile data 106 can be obtained from various suitable sources, such as a job aggregator, a job search engine, a social media site, a professional networking site, etc. In some implementations, the commute manager can be configured to “crawl” a plurality of websites to extract the profile data 106 from the websites. In some implementations, the profile data 106 can be stored in one or more databases associated with the system 100. The commute manager 102 can be configured to ascertain an origin location and a destination location associated with a frequently traveled commute based at least in part on the profile data 106. For instance, the origin location can be a location of a user's residence as specified by the profile data 106. The destination location can be a location of the user's place employment (e.g. job location), place of education (e.g. school location), etc., as specified by the profile data 106. In some implementations, commute manager 102 can designate the location associated with the most recently held job or most recently attended school specified by the profile data 106 as the destination location. In this manner, the commute manager 102 can identify temporal information associated with profile data 106 to determine such most recently held job, recently attended school, etc.

The profile data 106 may specify the origin location and/or the destination location with varying levels of granularity. For instance, the profile data 106 may specify the origin and/or destination locations with a high level of granularity (e.g. a full address associated with the origin and/or destination locations), or the profile data 106 may specify the origin and/or destination locations at a lower level of granularity (e.g. a city, neighborhood, street, etc. associated with the origin and/or destination locations). In this manner, the commute manager 102 may not be able to ascertain the origin and/or destination locations directly from the profile data 106. In such instances, the commute manager 102 can determine the origin and/or destination locations using one or more alternative sources. For instance, the commute manager 102 can perform a look-up of the entity associated with the origin and/or destination location based at least in part on the profile data using a suitable search engine or other tool to determine the origin and/or destination locations with a suitable specificity, such that a travel route between the origin location and the destination can be determined.

In some implementations, the commute manager 102 can determine a confidence score associated with the profile data 106, the origin location and/or the destination location. The confidence score can reflect a degree of confidence by the commute manager that the ascertained origin location and/or destination location accurately represents a commute that is frequently traveled by the user. The commute manager 102 can determine the confidence score based at least in part on the profile data 106, a source from which the profile data was obtained, or other metric. For instance, the commute manager 102 can determine the confidence score based at least in part on the level of granularity with which the origin and/or destination locations were specified in the profile data 106, a time at which the profile data 106 was created, a trustworthiness of the source from which the profile data 106 was obtained, a trustworthiness of the source from which the origin location and/or the destination location was ascertained, etc.

Upon a determination of the origin location and the destination location, the commute manager 102 can determine a frequently traveled commute associated with the user. The frequently traveled commute can correspond to a travel route between the origin location and the destination location. The travel route can be associated with one or more modes of transportation. For instance, the travel route can be associated with one or more of walking, cycling, driving, public transit (e.g. bus, train, subway, metro, trolley, taxi, rideshare, etc.), or other suitable mode of transportation. In some implementations, a first portion of the travel route can be associated with a first mode of transportation (e.g. walking), and a second portion of the travel route can be associated with a second mode of transportation (e.g. subway).

The travel route associated with the frequently traveled commute can represent a likely travel route traversed by the user between the origin location and the destination location. In this manner, the commute manager 102 can access transportation data 108 associated with the geographic area to determine the path(s) and/or the mode(s) of transportation likely taken by the user in traveling from the origin location to the destination location as part of the user's commute. For instance, the transportation data 108 can include infrastructure data associated with various modes of public transit present within the geographic area (e.g. transit routes, schedules, etc.), traffic data associated with the geographic area, commuter data specifying patterns, trends, preferences, etc. associated with travel of commuters within the geographic area. For instance, such commuter data can include survey data indicating various modes of transportation taken by various commuters within the geographic area. The commuter data can various suitable data that can be used to determine general traffic patterns and preferences of commuters in the geographic area.

In this manner, the commute manager 102 can use the transportation data 108 to determine the travel route associated with the frequently traveled commute. For instance, the commute manager 102 can determine a plurality of candidate travel routes between the origin location and the destination location associated with the frequently traveled commute. The candidate travel routes can be determined using any suitable routing technique. Each candidate travel route can be associated with a path to be traversed between the origin location and the destination location. Each candidate route can include one or more modes of transportation. The commute manager 102 can select a travel route to be associated with the frequently traveled commute based at least in part on the transportation data 108, and/or other suitable information. For instance, the commute manager 102 can select the selected travel route based at least in part on a time required to traverse the travel route, an amount of money required to traverse the travel route, and ease or convenience with which the travel route can be traversed (e.g. due to traffic, transit changes, etc.), or other suitable metric.

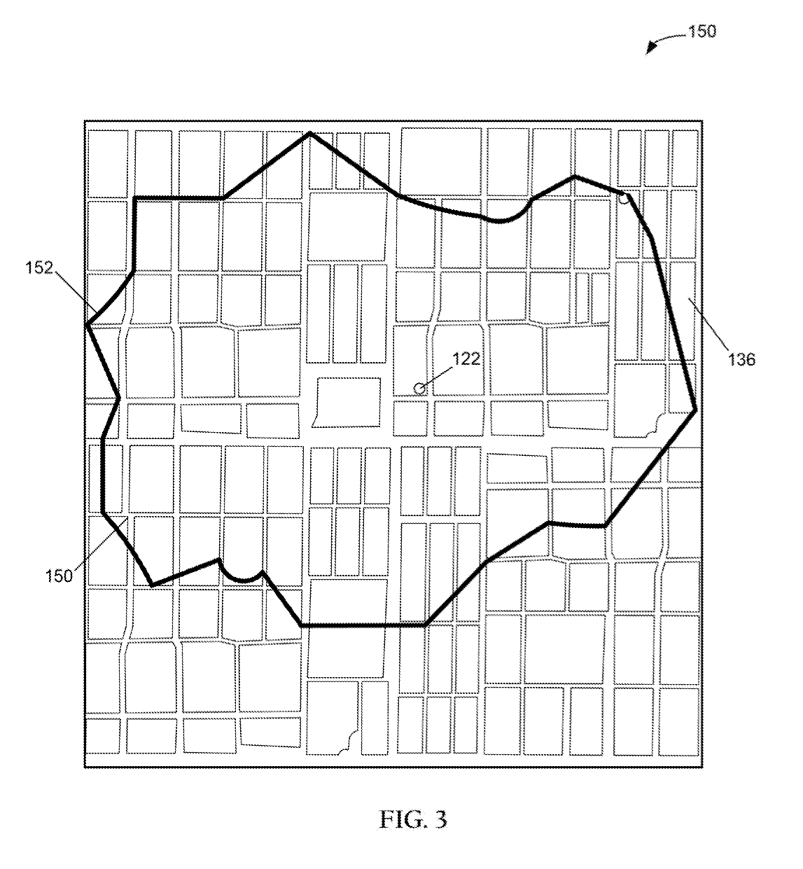

For instance, FIG. 2 depicts a representation of an example selected travel route 120 within a geographic area 136 according to example embodiments of the present disclosure. The travel route 120 can be travel route between an origin location 122 and a destination location 124. The origin location 122 and the destination location 124 can be determined, for instance, by the commute manager 102 according to example aspects of the present disclosure. The travel route 120 includes a plurality of portions or legs. More particularly, the travel route 120 includes portion 126, portion 128, and portion 130. Each portion can be associated with a particular mode of transportation. For instance, portion 126 can be associated with walking from the origin location 122 to a first transit stop 132. Portion 128 can be associated with traveling using a mode of public transit from the first transit stop 132 to a second transit stop 134. For instance, the portion 128 can correspond to a predefined transit route. The portion 130 can then be associated with walking from the second transit stop 134 to the destination location 124. It will be appreciated that the travel

Referring back to FIG. 1, the commute manager 102 can further determine a commute time associated with the selected travel route. The commute time can represent an average or likely time required to traverse the selected travel route. The commute time can be determined using any suitable technique. The commute time can be determined based at least in part on the transportation data (e.g. traffic data, transit routes, transit schedules, map data associated with the geographic area, speed limits associated with the geographic area, etc.). The commute time can represent an amount of time that the user is willing to spend commuting on a daily or other basis. For instance, it can be inferred that, since the user previously spent an amount of time approximately equivalent to the commute time commuting to work or school each morning, that the user is willing to spend a similar amount of time commuting in the future.

The commute manager 102 can determine a commute tolerance area based at least in part on the commute time. For instance, the commute tolerance area can represent an area within which the user is willing to commute. In this manner, it can be inferred that the user is willing to commute to any destination location within the commute tolerance area, but that the user is not willing to commute to a destination location outside of the commute tolerance area due to an amount of time required to travel to such destination locations. The commute tolerance area can be an area surrounding the origin location having an irregular, multidirectional shape.

The commute tolerance area can be determined based at least in part on the commute time, the geographic area, the transportation data 108, and/or other suitable information. In some implementations, the commute tolerance area can be an area within the geographic area surrounding the origin location having a radius equal to a distance between the origin location and the destination location. In some implementations, the commute manager 102 can determine a plurality of destination locations within the geographic area to which the user is willing to travel as part of the user's commute. In this manner, the commute manager 102 can determine such destination locations by identifying a plurality of candidate destination locations within the geographic area. The commute manager 102 can then determine a plurality of candidate travel routes between the origin location and the plurality of candidate destination locations. For instance, the commute manager 102 can determine one or more travel routes between the origin location and each candidate destination location. The commute manager 102 can determine the candidate travel routes using any suitable routing scheme or technique. The candidate travel routes can be associated with one or more modes of transportation. The commute manager 102 can further determine corresponding travel times associated with the candidate travel routes (e.g. a likely amount of time required to traverse the candidate travel route).

The commute manager 102 can then determine a commute tolerance area based at least in part on the plurality of candidate travel routes. For instance, the commute manager 102 can select a plurality of relevant travel routes from the plurality of candidate travel routes. The relevant travel routes can be determined based at least in part on the travel times associated with the candidate travel routes and the commute time determined for the user. The relevant travel routes can be travel routes that can be traversed in an amount of time less than or approximately equal to the commute time. The commute manager 102 can determine a commute tolerance area that encompasses each relevant travel route and/or each relevant destination location associated with each relevant travel route.

In some implementations, a perimeter of the commute tolerance area can intercept at least one relevant destination location. In some implementations, the perimeter of the commute tolerance area can intersect a plurality of apex destination locations. An apex destination location can be the relevant destination location in a particular direction relative to the origin location having located the farthest distance from the origin location. In this manner, the apex destination locations can be the outermost relevant destinations relative to the origin location. In some implementations, the commute tolerance area can extend beyond the apex destination locations.

FIG. 3 depicts an example commute tolerance area 150 within the geographic area 136 according to example embodiments of the present disclosure. In particular, FIG. 3 depicts an expanded portion of the geographic area 136. The commute tolerance area 150 can be an area within the geographic area defined by the perimeter 152. In this manner, the perimeter 152 can surround the origin location 122. As shown, the commute tolerance area 150 has an irregular, multidirectional shaped. As indicated, the shape of the commute tolerance area 150 can be determined by the commute manager 102 based at least in part on one or more relevant travel routes determined according to example aspects of the present disclosure. The multidirectional, irregular shape of the commute tolerance area 150 reflects the distances that can be traversed in various directions within the geographic area 136. For instance, the distance that can be traveled in a first direction relative to the origin location can be different than a distance that can be traveled in a second direction relative to the origin location. Such varying distances can be due to various characteristics associated with the geographic area, such as traffic patterns, public transit routes, public transit schedules, the road infrastructures, and/or other suitable characteristics. For instance, a first travel route to a first destination location near a public transit stop may be traversable in a shorter amount of time than a second travel route to a second destination location that is not near the public transit stop even though the straight line distances between the origin location and the first and second destination locations are the same.

It will be appreciated that the geographic area 136, the travel route 120, and the commute tolerance area 150 depicted in FIGS. 2 and 3 are depicted and described for illustrative purposes. It will be further appreciated that example aspects of the present disclosure can be implemented with respect to various suitable geographic areas to determine various suitable travel routes, commute tolerance areas, etc. without deviating from the scope of the present disclosure.

The commute tolerance area for a user can be used to surface job postings associated with various entities that may be relevant to a user. For instance, referring back to FIG. 1, the job posting manager 104 can be configured to obtain job posting data 110 associated with the geographic area. For instance, the job posting manager 104 can obtain job posting data 110 from one or more sources, such as employer web sites, job aggregators, job search sites, recruiter websites, staffing agency websites, social networks, professional networks, or other suitable source. The job posting data 110 can describe one or more job opportunities posted by various third party entities, such as employers, staffing agencies, recruiters, etc. The job posting manager 104 can obtain the job posting data 110 using any suitable job surfacing techniques. For instance, the job posting manager 104 can be configured to crawl webpages (e.g., employer job listing pages, job sites, recruiting sites, social media, professional networking sites) to obtain data indicative of the job postings. In some implementations, at least a portion of the job posting data 110 can be stored in one or more databases associated with the system 100. Such data can include one or more characteristic(s) associated with the job postings. In particular, such data can include a location of the jobs that the job postings describe.

Upon obtaining the job posting data 110, the job posting manager 104 can compare the location associated with the job postings to the commute tolerance area. The job posting manager 104 can identify one or more relevant job postings having associated locations within the commute tolerance area. Data indicative of one or more of the relevant job postings can then be provided to the user. For instance, the system 100 can provide the data indicative of the one or more relevant job postings to a user computing device associated with the user. In some implementations, user data associated with the user (e.g. profile data) can be provided to the entities associated with one or more relevant job postings. For instance, the user data can be provided to the entity that posted the relevant job posting(s) and/or directly to the employers.

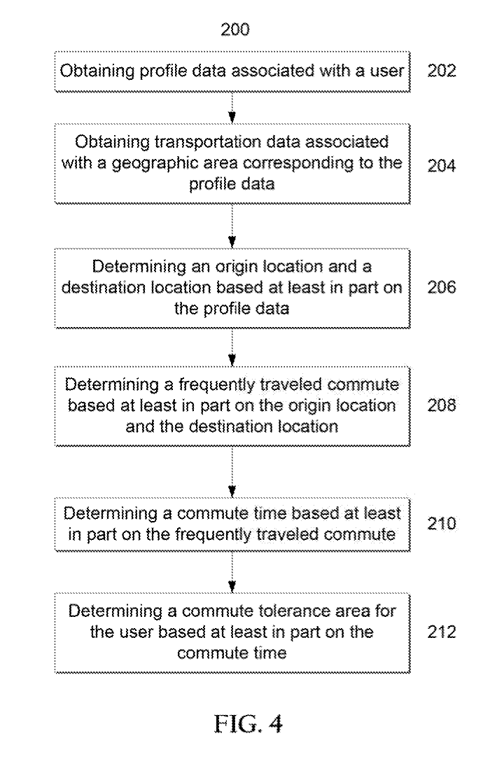

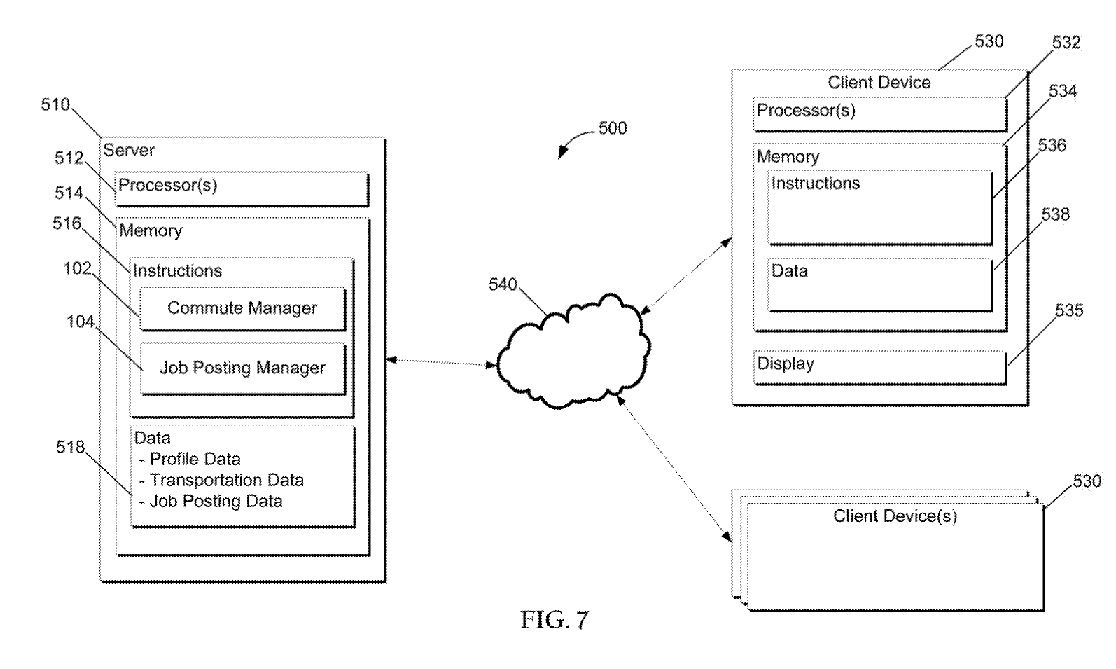

FIG. 4 depicts a flow diagram of an example method (200) of determining a commute tolerance area for a user according to example embodiments of the present disclosure. The method (200) can be implemented by one or more computing devices, such as one or more of the computing devices depicted in FIG. 7. In particular implementations, the method (200) can be implemented by the commute manager 102 depicted in FIG. 1. In addition, FIG. 4 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (202), the method (200) can include obtaining profile data associated with a user. For instance, the profile data can include the profile data can include data relating to a resume of the user, a work history of the user, a social network profile of the user, a professional network profile of the user, a profile associated with a suitable job aggregator, job search engine, etc., or other suitable profile data. The profile data can be obtained from various suitable sources. For instance, the profile data can be obtained by a computing system configured to “crawl” a plurality of websites to obtain the profile data. In some implementations, the profile data can be stored in one or more databases associated with the system 100

At (204), the method (200) can include obtaining transportation data associated with a geographic area corresponding to the profile data. The transportation data can include infrastructure data associated with various modes of public transit present within the geographic area (e.g. transit routes, schedules, etc.), traffic data associated with the geographic area, commuter data specifying patterns, trends, preferences, etc. associated with travel of commuters within the geographic area, or other suitable data.

At (206), the method (200) can include determining an origin location and a destination location associated with a frequently traveled commute based at least in part on the profiled data. For instance, the origin location can correspond to a location of the user's residence as specified by the profile data. The destination location can correspond to a location of a place of employment of the user (e.g. a current place of employment or a previous place of employment), as specified by the profile data. For instance, the destination location can be designated as a location of current place of employment or a most recent place of employment as specified by the profile data.

In some implementations, the origin location and/or the destination location can be ascertained from one or more alternate sources. For instance, if the profile data does not specify the origin location and/or the destination location with a suitable of level of specificity such that a travel route between the origin and the destination locations can be determined, the origin location and/or the destination locations can be ascertained from one or more other sources (e.g. websites, listings, databases, etc.).

At (208), the method (200) can include determining a frequently traveled commute of the user based at least in part on the origin location and the destination location. The frequently traveled commute can correspond to a travel route between the origin location and the destination location. The travel route can be associated with one or more modes of transportation. The travel route can include one or more portions. In some implementations, each portion can be associated with a particular mode of transportation.

The frequently traveled commute (e.g. the travel route) can be determined based at least in part on the transportation data. For instance, the transportation data can be accessed to determine one or more likely modes of transportation taken by the user in making the frequently traveled commute. In this manner, the frequently traveled commute can be determined based at least in part on traffic patterns, public transit routes, public transit schedules, commuter data (e.g. popularity of various modes of transportation among users), etc.

At (210), the method (200) can include determining a commute time based at least in part on the frequently traveled commute. The commute time can be an estimated amount of time required to traverse the travel route. The commute time can be determined using various suitable routing techniques. The commute time can represent an amount of time that the user is willing to travel in making a commute.

At (212), the method (200) can include determining a commute tolerance area for the user based at least in part on the commute time. The commute tolerance area can correspond to an area within which the user is willing to travel. For instance, the commute tolerance area can encompass a plurality of locations to which the user can travel from the origin location within the commute time. The commute tolerance area can be an area the surrounds the origin location. The commute tolerance area can have an irregular, multidirectional shape that reflects an ability of the user to commute to the plurality of locations from the origin location within the commute time.

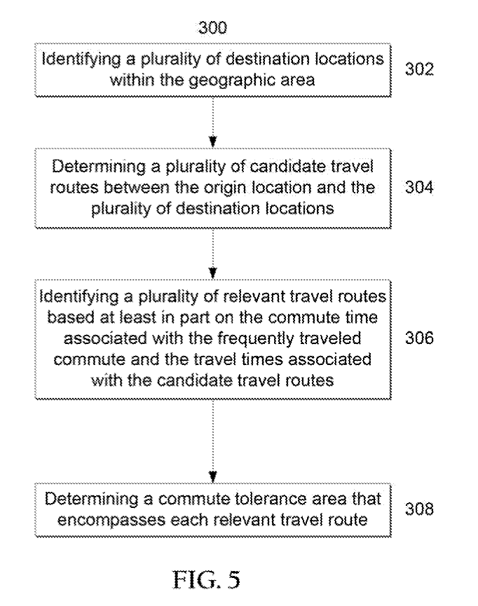

The commute tolerance area can be determined in various suitable manners. For instance, FIG. 5 depicts a flow diagram of an example method (300) of determining a commute tolerance area for a user according to example embodiments of the present disclosure. The method (300) can be implemented by one or more computing devices, such as one or more of the computing devices depicted in FIG. 7. In particular implementations, the method (300) can be implemented by the commute manager 102 depicted in FIG. 1. In addition, FIG. 5 depicts steps performed in a particular order for purposes of illustration and discussion.

At (302), the method (300) can include identifying a plurality of candidate destination locations within the geographic area. A candidate destination location can be any suitable location within the geographic area. In some implementations, the candidate destination locations can be located within a threshold of the origin location.

At (304), the method (300) can include determining a plurality of candidate travel routes between the origin location and the plurality of candidate destination locations. The travel routes can be determined using any suitable routing technique. The candidate travel routes can include a path to the destination location from the origin location using one or more suitable modes of transportation. In this manner, one or more candidate travel routes can be determined between the origin location and each candidate destination location.

At (306), the method (300) can include identifying a plurality of relevant travel routes based at least in part on the commute time associated with the frequently traveled commute (e.g. as determined in (210) of FIG. 4) and the travel times associated with the candidate travel routes. The travel times can represent an estimated amount of time required to traverse the candidate travel routes. For instance, the relevant travel routes can be travel routes having an associated travel time that is less than or approximately equal to (e.g. within 30% of) the commute time associated with the frequently traveled commute. In this manner, the relevant travel routes can be travel routes that the user is expected to be able to complete within a comparable amount of time to the time required to complete the frequently traveled commute.

At (308), the method (300) can include determining a commute tolerance area that encompasses each relevant travel route and/or each relevant destination location associated with each travel route. For instance, the commute tolerance area can have a perimeter that intersects at least one relevant destination location. In some implementations, the perimeter can intersect each apex (e.g. outermost) relevant destination location. In some implementations, the perimeter can extend beyond the apex relevant destination locations.

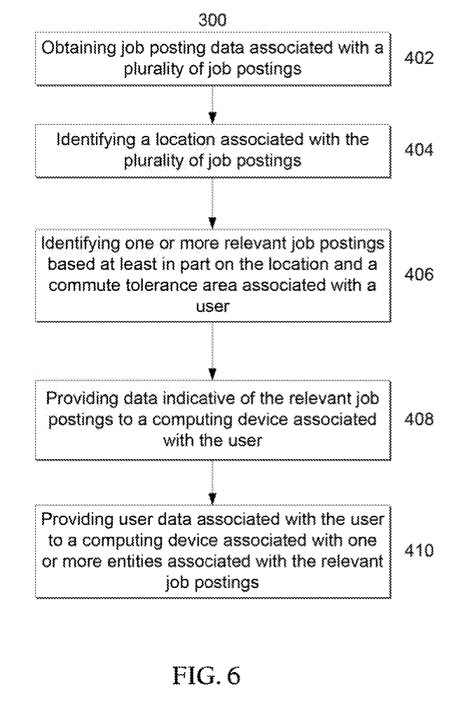

The commuter tolerance area can be used for various suitable purposes. For instance, in some implementations, the commute tolerance areas can be used to surface relevant job postings associated with the user. In this manner, FIG. 6 depicts a flow diagram of an example method (400) of identifying relevant job postings for a user according to example embodiments of the present disclosure. The method (400) can be implemented by one or more computing devices, such as one or more of the computing devices depicted in FIG. 7. In particular implementations, the method (400) can be implemented by the job posting manager 104 depicted in FIG. 1. In addition, FIG. 6 depicts steps performed in a particular order for purposes of illustration and discussion.

At (402), the method (400) can include obtaining job posting data associated with a plurality of job postings. Such job posting data can describe one or more job opportunities posted by various third party entities, such as employers, staffing agencies, recruiters, etc. For instance, the job posting data can be obtained by a computing system configured to crawl webpages (e.g., employer job listing pages, job sites, recruiting sites, social media, professional networking sites) to obtain the data indicative of the job postings.

At (404), the method (400) can include identifying a location associated with each job posting. For instance, the obtained job posting data can include one or more characteristic(s) associated with the job postings. In particular, such data can include respective locations of the jobs for which job postings reference. Such locations can be identified by a suitable computing system from the job posting data.

At (406), the method (400) can include identifying one or more relevant job postings based at least in part on the obtained locations and a commute tolerance area associated with a user. The commute tolerance area can be a commute tolerance area determined in accordance with example aspects of the present disclosure. In particular, the commute tolerance area can define an estimated area within which the user is willing to commute. In this manner, the identifying the relevant job postings can include determining one or more job postings having associated locations within the commute tolerance area.

At (408), the method (400) can include providing data indicative of one or more of the relevant job postings to a computing device associated with the user. For instance, such data indicative of the relevant job postings can include information specified within the job posting. In this manner, the user can be alerted to available jobs within a location to which the user is likely willing to commute.

At (410), the method (400) can include providing data associated with the user to a computing device associated with one or more entities associated with the relevant job postings. Such data associated with the user can include information specified within profile data associated with the user or other information. In this manner, entities that post job postings of available jobs can be alerted to users who are likely willing to commute to the jobs. It will be appreciated that (410) can be performed in addition to or instead of (408). It will further be understood that the steps of the methods as discussed above with reference to the accompanying Figures may be carried out as part of a search procedure initiated by a user. For example, with reference to FIG. 6, the method (400) may be carried out in response to a user entering a search query in a search engine; upon receipt of the search query, the search engine may implement steps 402 to 408 in order to provide the user with job postings relevant to that query.

Although the example aspects of the present disclosure describe commute tolerance areas that are used to surface relevant job postings, it will be appreciated that such commute tolerance areas can be used for various other suitable applications or purposes. For Commute tolerance areas can be used by various businesses, organizations etc. for various suitable purposes. For instance, such businesses can use commute tolerance areas to gain an understanding of potential customer travel patterns, trends, preferences, etc. In this manner, such commute tolerance areas associated with a geographic area can be aggregated to determine high level trends, patterns, etc. of travel and transportation within the geographic area.

FIG. 7 depicts an example computing system 500 that can be used to implement the methods and systems according to example aspects of the present disclosure. The system 500 can be implemented using a client-server architecture that includes a server 510 that communicates with one or more client devices 530 over a network 540. The system 500 can be implemented using other suitable architectures, such as a single computing device.

The system 500 includes a server 510, such as a web server. The server 510 can host or can otherwise be associated with a geographic information system, such as a geographic information system associated with a mapping service. The server 510 can be implemented using any suitable computing device(s). The server 510 can have one or more processors 512 and one or more memory devices 514. The server 510 can also include a network interface used to communicate with one or more client devices 530 over the network 540. The network interface can include any suitable components for interfacing with one more networks, including for example, transmitters, receivers, ports, controllers, antennas, or other suitable components.

The one or more processors 512 can include any suitable processing device, such as a microprocessor, microcontroller, integrated circuit, logic device, or other suitable processing device. The one or more memory devices 514 can include one or more computer-readable media, including, but not limited to, non-transitory computer-readable media, RAM, ROM, hard drives, flash drives, or other memory devices. The one or more memory devices 514 can store information accessible by the one or more processors 512, including computer-readable instructions 516 that can be executed by the one or more processors 512. The instructions 516 can be any set of instructions that when executed by the one or more processors 512, cause the one or more processors 512 to perform operations. For instance, the instructions 516 can be executed by the one or more processors 512 to implement the commute manager 102 and the job posting manager 104 described with reference to FIG. 1.

As shown in FIG. 7, the one or more memory devices 514 can also store data 518 that can be retrieved, manipulated, created, or stored by the one or more processors 512. The data 518 can include, for instance, transportation data, profile data, job posting data, commute tolerance area determined according to example aspects of the present disclosure, and other data. The data 518 can be stored in one or more databases. The one or more databases can be connected to the server 510 by a high bandwidth LAN or WAN, or can also be connected to server 510 through network 540. The one or more databases can be split up so that they are located in multiple locales.

The server 510 can exchange data with one or more client devices 530 over the network 540. Although two client devices 530 are illustrated in FIG. 7, any number of client devices 530 can be connected to the server 510 over the network 540. Each of the client devices 530 can be any suitable type of computing device, such as a general purpose computer, special purpose computer, laptop, desktop, mobile device, navigation system, smartphone, tablet, wearable computing device, a display with one or more processors, or other suitable computing device.

Similar to the server 510, a client device 530 can include one or more processor(s) 532 and a memory 534. The one or more processor(s) 532 can include one or more central processing units (CPUs), graphics processing units (GPUs) dedicated to efficiently rendering images or performing other specialized calculations, and/or other processing devices. The memory 534 can include one or more computer-readable media and can store information accessible by the one or more processors 532, including instructions 536 that can be executed by the one or more processors 532 and data 538. For instance, the memory 534 can store instructions 536 for implementing a user interface module for displaying relevant job postings determined according to example aspects of the present disclosure.

The client device 530 of FIG. 7 can include various input/output devices for providing and receiving information from a user, such as a touch screen, touch pad, data entry keys, speakers, and/or a microphone suitable for voice recognition. For instance, the client device 530 can have a display device 535 for presenting a user interface displaying relevant job postings determined according to example aspects of the present disclosure.

The client device 530 can also include a network interface used to communicate with one or more remote computing devices (e.g. server 510) over the network 540. The network interface can include any suitable components for interfacing with one more networks, including for example, transmitters, receivers, ports, controllers, antennas, or other suitable components.

The network 540 can be any type of communications network, such as a local area network (e.g. intranet), wide area network (e.g. Internet), cellular network, or some combination thereof. The network 540 can also include a direct connection between a client device 530 and the server 510. In general, communication between the server 510 and a client device 530 can be carried via network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of determining a commute tolerance for a user, the method comprising:
obtaining, by one or more computing devices, profile data associated with a user;
obtaining, by the one or more computing devices, transportation data associated with a geographic area, the geographic area being determined based at least in part on the profile data;
determining, by the one or more computing devices, a frequently traveled commute of the user within the geographic area based at least in part on an origin location and a destination location, the origin location and the destination location being determined based at least in part on the profile data;
determining, by the one or more computing devices, a commute time associated with the frequently traveled commute based at least in part on the origin location and the destination location and the transportation data;
determining, by the one or more computing devices, a commute tolerance area within the geographic area based at least in part on commute time; and
selecting, by the one or more computing devices, one or more objects for display to the user based at least in part on the commute tolerance area.

2. The computer-implemented method of claim 1, wherein determining, by the one or more computing devices, a commute tolerance area comprises:
determining, by the one or more computing devices, a plurality of candidate travel routes from the origin location to a plurality of candidate destination locations;
determining, by the one or more computing devices, a plurality of relevant travel routes from the plurality of candidate travel routes based at least in part on the commute time associated with the frequently traveled commute and travel times associated with the candidate travel routes; and
determining, by the one or more computing devices, a commute tolerance area based at least in part on the relevant travel routes.

3. The computer-implemented method of claim 2, wherein the commute tolerance area encompasses each relevant travel route.

4. The computer-implemented method of claim 3, wherein each relevant travel route is comprises a travel route from the origin location to a relevant destination location, and wherein the commute tolerance area encompasses each relevant destination location.

5. The computer-implemented method of claim 4, wherein a perimeter of the commute tolerance area intersects at least one relevant destination location.

6. The computer-implemented method of claim 3 wherein a perimeter of the commute tolerance area intersects at least one apex relevant destination location.

7. The computer-implemented method of claim 1, wherein the one or more objects comprise one or more relevant job postings, and wherein selecting, by the one or more computing devices, one or more objects for display to the user comprises providing, by the one or more computing devices, data indicative of the one or more relevant job postings to a user computing device associated with the user.

8. The computer-implemented method of claim 8, further comprising:
obtaining, by the one or more computing devices, data indicative of a plurality of job postings; and
identifying, by the one or more computing devices, one or more relevant job postings having associated locations located within the commute tolerance area.

9. The computer-implemented method of claim 7, further comprising, providing, by the one or more computing devices, user data associated with the user to one or more computing devices associated with one or more entities that posted the one or more relevant job postings.

10. A computing system, comprising:
one or more processors; and
one or more memory devices, the one or more memory devices storing computer-readable instructions that when executed by the one or more processors cause the one or more processors to perform operations, the operations comprising:
obtaining profile data associated with a user;
obtaining transportation data associated with a geographic area, the geographic area being determined based at least in part on the profile data;
determining a frequently traveled commute of the user within the geographic area based at least in part on an origin location and a destination location determined based at least in part on the profile data;
determining a commute time associated with the frequently traveled commute based at least in part on the origin location and the destination location and the transportation data; and
determining a commute tolerance area within the geographic area based at least in part on commute time and the transportation data.

11. The computing system of claim 10, the operations further comprising determining the origin location and the destination location based at least in part on the profile data.

12. The computing system of claim 10, wherein determining a commute tolerance area comprises:
determining a plurality of candidate travel routes from the origin location to a plurality of candidate destination locations;
determining a plurality of relevant travel routes from the plurality of candidate travel routes based at least in part on the commute time associated with the frequently traveled commute and travel times associated with the candidate travel routes; and
determining a commute tolerance area based at least in part on the relevant travel routes.

13. The computing system of claim 12, wherein the commute tolerance area encompasses each relevant travel route.

14. The computing system of claim 10, the operations further comprising:
obtaining data indicative of a plurality of job postings; and
identifying one or more relevant job postings having associated locations located within the commute tolerance area.

15. The computing system of claim 14, the operations further comprising, providing data indicative of the one or more relevant job postings to a user computing device associated with the user.

16. One or more tangible, non-transitory computer-readable media storing computer-readable instructions that when executed by one or more processors cause the one or more processors to perform operations, the operations comprising:
obtaining profile data associated with a user;
obtaining transportation data associated with a geographic area, the geographic area being determined based at least in part on the profile data;
determining a frequently traveled commute of the user within the geographic area based at least in part on an origin location and a destination location determined based at least in part on the profile data;
determining a commute time associated with the frequently traveled commute based at least in part on the origin location and the destination location and the transportation data; and
determining a commute tolerance area within the geographic area based at least in part on commute time and the transportation data.

17. The one or more tangible, non-transitory computer-readable media of claim 16, wherein determining a commute tolerance area comprises:
determining a plurality of candidate travel routes from the origin location to a plurality of candidate destination locations;
determining a plurality of relevant travel routes from the plurality of candidate travel routes based at least in part on the commute time associated with the frequently traveled commute and travel times associated with the candidate travel routes; and
determining a commute tolerance area based at least in part on the relevant travel routes.

18. The one or more tangible, non-transitory computer-readable media of claim 16, wherein the commute tolerance area encompasses each relevant travel route.

19. The one or more tangible, non-transitory computer-readable media of claim 16, the operations further comprising:
obtaining data indicative of a plurality of job postings; and
identifying one or more relevant job postings having associated locations located within the commute tolerance area.

20. The one or more tangible, non-transitory computer-readable media of claim 19, the operations further comprising providing user data associated with the user to one or more computing devices associated with one or more entities that posted the one or more relevant job postings.
